(19) United States
(12) Patent Application Publication
(10) Pub. No.: US 2014/0320087 A1
(43) Pub. Date: Oct. 30, 2014

(54) CONTROL APPARATUS AND CONTROL METHOD FOR ELECTRICITY STORAGE DEVICE

(71) Applicant: Kenji Takahashi, Toyota-shi (JP)

(72) Inventor: Kenji Takahashi, Toyota-shi (JP)

(73) Assignee: TOYOTA JIDOSHA KABUSHIKI KAISHA, Toyota-shi (JP)

(21) Appl. No.: 14/361,499

(22) PCT Filed: Nov. 29, 2012
(86) PCT No.: PCT/IB2012/002545

§ 371 Date: May 29, 2014

(30) Foreign Application Priority Data
Dec. 1, 2011 (JP) 2011-263833

(51) Int. Cl. H02J 7/00

(52) U.S. Cl. CPC H02J 7/007
USPC 320/134

(57) ABSTRACT

A control method controls the charging and discharging of an electricity storage device. In this control method, the temperature of a reference point inside the electricity storage device is calculated by using the temperature occurring outside the electricity storage device and an expression that expresses movement of heat. An upper-limit electric power that is used in the charging control or the discharging control of the electricity storage device is set to an electric power that corresponds to the calculated temperature of the reference point. The reference point is a grid point that exhibits a temperature that corresponds to, the internal resistance of the electricity storage device, of a plurality of grid points provided inside the electricity storage device.

### BACKGROUND OF THE INVENTION

1. Field of the Invention

The invention relates to a control apparatus and a control method that control the charging and discharging of an electricity storage device.

2. Description of Related Art

When the charging and discharging of an electric cell is to be controlled, the temperature of the electric cell is detected, and the detected temperature is used as a control parameter. For example, as shown in Japanese Patent Application Publication No. 2007-288906 (JP 2007-288906 A), usually in the case where the temperature of an electric cell is to be detected, a temperature sensor, such as a thermocouple or the like, is used, and is attached to an external surface of the electric cell.

Inside the electric cell there occurs a dispersion in the temperature distribution due to the heat dissipation characteristic or the like. Generally, the temperature in a center portion of an electric cell is likely to be higher than the temperature on the external surface of the electric cell. In an electric cell that has such a temperature distribution, the temperature occurring inside the electric cell cannot be acquired or detected merely by using the output of a temperature sensor attached to the external surface of the electric cell.

### SUMMARY OF THE INVENTION

The invention has been accomplished in view of the foregoing problem. According to one aspect of the invention, there is provided a control method as described below which controls the charging and discharging of an electricity storage device. In the method, temperature of a reference point inside the electricity storage device is calculated by using temperature occurring outside the electricity storage device and an expression that expresses movement of heat. Then, an upper-limit electric power that is used in a charging control of the electricity storage device or a discharging control of the electricity storage device is set to an electric power that corresponds to the calculated temperature of the reference point. The reference point is a grid point that exhibits temperature that corresponds to internal resistance of the electricity storage device, of a plurality of grid points provided inside the electricity storage device.

In the above-described control method, the upper-limit electric power may be set to an electric power that corresponds to the calculated temperature of the reference point and to state of charge of the electricity storage device. Therefore, the upper-limit electric power can be set by factoring in the state of charge of the electricity storage device as well. The state of charge (SOC) of a battery is the percentage of the present amount of charge (i.e. the present amount of accumulated electricity) to the full charge capacity of the battery.

Furthermore, in the control method, the temperature of the reference point may be calculated by using temperature on an external surface of the electricity storage device and a heat conduction equation. Herein, the heat conduction equation can be expressed as in the following Expression (I).

$$\frac{{T}_{i} ( t + Δ t ) - {T}_{i} ( t )}{Δ t} = ( \frac{λ}{ρ c} ) \frac{{T}_{i + 1} ( t ) - 2 {T}_{i} ( t ) + {T}_{i - 1} ( t )}{Δ {x}^{2}} + \frac{{q}_{i} ( t )}{ρ c} \qquad ( I )$$

where T is temperature, t is time, λ is thermal conductivity, ρ is density, c is specific heat, x is thermal diffusion length, q is amount of heat production per unit volume, and a subscript i indicates a value occurring at the reference point.

Furthermore, the heat conduction equation can also be expressed as in the following Expression (II).

$$\frac{{T}_{p} ( t + Δ t ) - {T}_{p} ( t )}{Δ t} = {k}_{1} ( \frac{λ}{ρ c} ) \frac{{T}_{s} ( t ) - 2 {T}_{p} ( t ) + {T}_{s} ( t )}{Δ {x}^{2}} + {k}_{2} \frac{{q}_{p} ( t )}{ρ c} \qquad ( II )$$

where Tₚ is the temperature at the reference point, Tₛ is the temperature on the external surface of the electricity storage device (11), t is time, λ is thermal conductivity, ρ is density, c is specific heat, x is thermal diffusion length, qₚ is amount of heat production per unit volume at the reference point, and k₁ and k₂ are correction coefficients.

Still further, in the control method, the reference point may be determined by following a procedure described below. Firstly, the internal resistance of the electricity storage device is measured. Then, a map that shows a relationship between the temperature of the electricity storage device and the internal resistance of the electricity storage device is created beforehand by using the electricity storage device whose temperature distribution has been uniformed. By using the map, the temperature that corresponds to the measured internal resistance is specifically determined. The temperatures occurring at the plurality of grid points are calculated by using the temperature occurring outside the electricity storage device and the expression that expresses movement of heat. Herein, the reference point is a grid point, of the plurality of grid points, that exhibits a temperature that is closest to the temperature that corresponds to the internal resistance.

Further, in the control method, the electricity storage device may have an electricity generation and a case that houses the electricity generation component, and the electricity component may be configured by superimposing a positive electrode element, a separator and a negative electrode element on each other, and the plurality of grid points are different from each other in location in a superimposition direction of the electricity generation component, that is, a direction in which the positive electrode element, the separator and the negative electrode element are superimposed on each other. By connecting a plurality of such electricity storage devices in series or parallel, an electricity storage apparatus can be composed.

According to another aspect of the invention, there is provided a control apparatus that controls charging and discharging of an electricity storage device and that has a controller that sets an upper-limit electric power that is used in a charging control of the electricity storage device or a discharging control of the electricity storage device. The controller calculates temperature of a reference point inside the electricity storage device by using temperature occurring outside the electricity storage device and an expression that expresses movement of heat. Then, the controller sets an electric power that corresponds to the calculated temperature of the reference point as the upper-limit electric power. Herein, the reference point is a grid point that exhibits temperature that corresponds to internal resistance of the electricity storage device, of a plurality of grid points provided inside the electricity storage device.

In the control apparatus, the temperature of the reference point may be calculated by using temperature on an external surface of the electricity storage device and a heat conduction equation. The temperature on the external surface of the electricity storage device can be acquired if a temperature sensor is attached to the external surface of the electricity storage device. Data that indicates a correspondence relationship between the upper-limit electric power and the temperature may be stored in a memory. The controller may set the upper-limit electric power by using the data stored in the memory.

According to the control method and the control apparatus described above, because a reference point (a grid point) that exhibits temperature corresponding to the internal resistance of the electricity storage device is specifically determined, the temperature that corresponds to the internal resistance can be estimated by calculating the temperature of the reference point. Furthermore, by setting the upper-limit electric power through the use of the temperature that corresponds to the internal resistance, the charging or discharging of the electricity storage device suitable to the performance of the electricity storage device can be carried out.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a diagram showing a construction of a battery system concerned with a first embodiment of the invention;

FIG. 2 is a schematic diagram showing a construction of an electric cell shown in FIG. 1;

FIG. 3 is a schematic diagram showing a construction of an electricity generation component shown in FIG. 2;

FIG. 4 is a sectional view showing a construction of the electricity generation component shown in FIG. 2;

FIG. 5 is a diagram showing a temperature distribution inside the electric cell shown in FIG. 2;

FIG. 6 is a diagram illustrating a plurality of grid points that are different from each other in location in a thickness direction of the electric cell shown in FIG. 2

FIG. 7 is a diagram illustrating the grid points shown in FIG. 2;

FIG. 8 is a flowchart illustrating a method of specifically determining a grid point i that exhibits a performance temperature in the first embodiment;

FIG. 9 is a diagram showing a relationship between the resistance and the temperature of the electric cell shown in FIG. 2

FIG. 10 is a diagram of a charging-discharging pattern during a heat production period of the electric cell shown in FIG. 2;

FIG. 11 is a diagram showing a charging-discharging pattern during a temperature decrease period of the electric cell shown in FIG. 2;

FIG. 12 is a diagram showing the resistance of the electric cell shown in FIG. 2 during the heat production period and the temperature decrease period;

FIG. 13 is a diagram showing the performance temperature and the detected temperature of the electric cell shown in FIG. 2 during the heat production period and the temperature decrease period;

FIG. 14 is a flowchart showing a process of setting an upper limit value that is used in a charging-discharging control of the electric cell in the first embodiment;

FIG. 15 is a diagram showing relationships of the output upper limit value with the temperature and the SOC of the electric cell shown in FIG. 2;

FIG. 16 is a diagram showing a second embodiment of the invention in which three grid points are provided in an electric cell; and

FIG. 17 is a diagram illustrating a method of calculating correction coefficients k₁ and k₂ in the second embodiment of the invention.

### DETAILED DESCRIPTION OF EMBODIMENTS

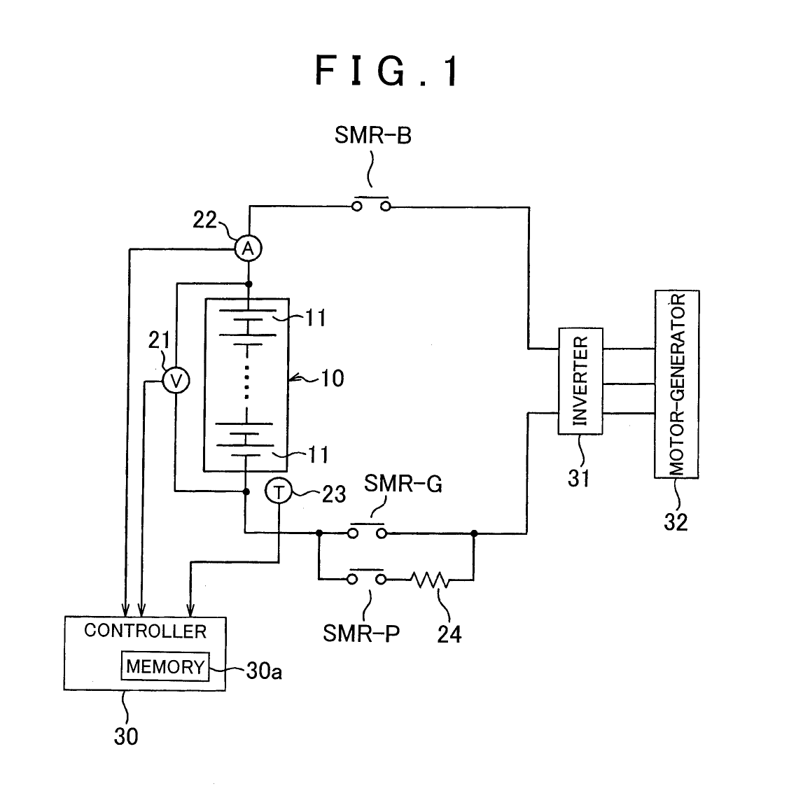

First and second embodiments of the invention will be described hereinafter with reference to FIGS. 1 to 17. A battery system concerned with a control apparatus in accordance with a first embodiment of the invention will be described with reference to FIG. 1. FIG. 1 is a diagram showing a construction of a battery system. The battery system in accordance with the embodiment can be mounted in a vehicle.

The battery system of the embodiment has an assembled battery 10. The assembled battery 10 has a plurality of electric cells 11 that are connected in series. The electric cells (corresponding to electricity storage devices) 11 used in the embodiment can be secondary cells such as nickel metal hydride cells or lithium-ion cells. Furthermore, instead of secondary cells, electric double layer capacitors can also be used. The number of the electric cells 11 can be appropriately set on the basis of the required output or the like. Although in this embodiment, the electric cells 11 are connected in series, a plurality of electric cells 11 connected in parallel may be included in the assembled battery 10.

A voltage sensor 21 detects the inter-terminal voltage (total voltage) of the assembled battery 10, and outputs results of detection to a controller 30. It is to be noted herein that by using the voltage sensor 21, it is possible to detect the voltage of each electric cell 11 or the voltage of a cell block that includes at least two electric cells 11. An electric current sensor 22 detects a charge/discharge current that flows through the assembled battery 10, and outputs results of detection to the controller 30.

A temperature sensor 23 detects the temperature of the electric cells 11, and outputs results of detection to the controller 30. The number of temperature sensors 23 employed can be appropriately set. If a plurality of temperature sensors 23 are used, the temperature sensors 23 can be disposed at electric cells 11 that are different from each other in location.

The controller 30 has a memory 30a. The memory 30a stores various pieces of information that are used for the controller 30 to perform predetermined processes. Although in the embodiment, the memory 30a is contained in the controller 30, the memory 30a may be provided outside the controller 30.

A system main relay SMR-B is connected to a positive electrode terminal of the assembled battery 10. The system main relay SMR-B switches between the on-state and the off-state, upon receiving a control signal from the controller 30. A system main relay SMR-G is connected to a negative electrode terminal of the assembled battery 10. The system main relay SMR-G, receiving a control signal from the controller 30, switches between the on-state and the off-state.

A system main relay SMR-P and a limiting resistor 24 are connected in parallel with the system main relay SMR-G The system main relay SMR-P, receiving a control signal from the controller 30, switches between the on-state and the off-state. The limiting resistor 34 is used to restrain inrush current from flowing when the assembled battery 10 is connected to an inverter 31.

When the assembled battery 10 is to be connected to the inverter 31, the controller 30 switches the system main relay SMR-B from the on-state to the off-state, and switches the system main relay SMR-P from the off-state to the on-state. Thus, current flows through the limiting resistor 24. Next, the controller 30 switches the system main relay SMR-G from the off-state to the on-state, and then switches the system main relay SMR-P from the on-state to the off-state.

Thus, connection of the assembled battery 10 and the inverter 31 is completed. On the other hand, when the connection between the assembled battery 10 and the inverter 31 is discontinued, the controller 30 switches the system main relays SMR-B and SMR-G from the on-state to the off-state.

The inverter 31 converts direct-current electric power from the assembled battery 10 into alternating-current electric power, and outputs the converted alternating-current electric power to a motor-generator 32. The motor-generator 32 used herein can be, for example, a three-phase alternating-current motor. The motor-generator 32, receiving alternating-current electric power from the inverter 31, generates kinetic energy for driving the vehicle. Kinetic energy generated by the motor-generator 32 is transferred to wheels.

When the vehicle is decelerated or stopped, the motor-generator 32 converts kinetic energy generated due to the braking of the vehicle into electric energy (alternating-current electric power). The inverter 31 converts the alternating-current electric power generated by the motor-generator 32 into direct-current electric power, and outputs the direct-current electric power to the assembled battery 10. Thus, the assembled battery 10 can store regenerative electric power.

Although in the embodiment, the assembled battery 10 is connected to the inverter 31, this construction is not restrictive. Concretely, a voltage boost circuit can be disposed between the assembled battery 10 and the inverter 31. The use of the voltage boost circuit makes it possible to boost the output voltage of the assembled battery 10. Furthermore, the voltage boost circuit is able to lower the voltage supplied from the inverter 31 to the assembled battery 10.

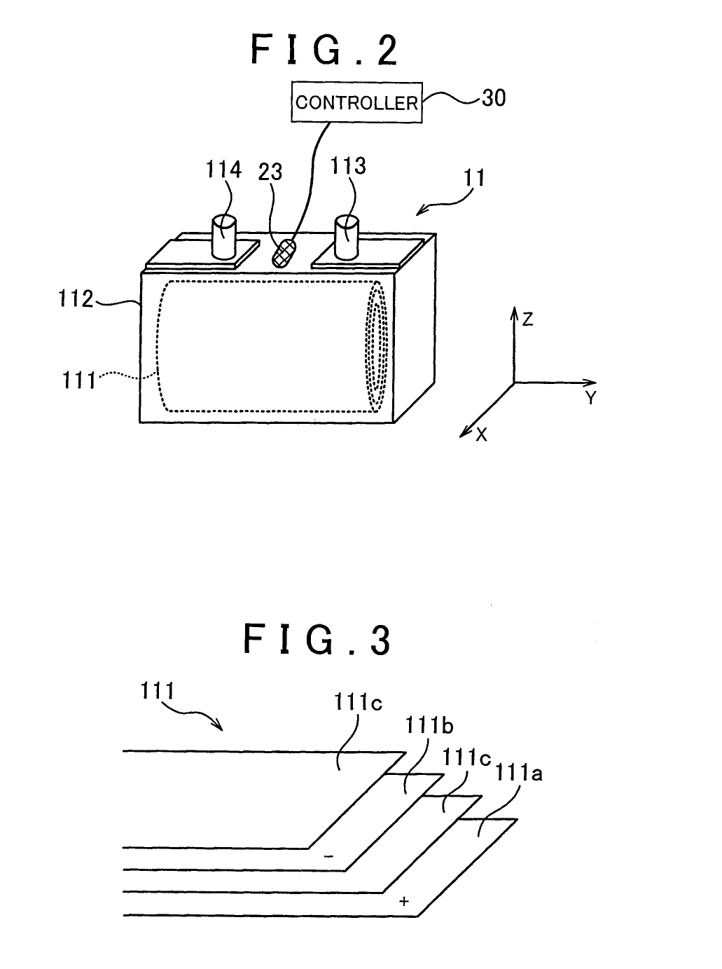

Next, a structure of each electric cell 11 will be described with reference to FIG. 2. FIG. 2 is a schematic diagram showing a structure of an electric cell 11. In FIG. 2, X, Y and Z axes are orthogonal to each other, and the relationship between the X axis, the Y axis and the Z axis remain the same in other drawings as well.

The electric cell 11 has an electricity generation component 111 and a cell case 112 that houses the electricity generation component 111. The electricity generation component 111 is an element that performs charging and discharging. As shown in FIG. 3, the electricity generation component 111 has a positive electrode element 111a, a negative electrode element 111b and a separator 111c disposed between the positive electrode element 111a and the negative electrode element 111b. Each separator 111c contains an electrolytic solution. The electricity generation component 111 is constructed by superimposing the positive electrode element 111a, the separator 111c and the negative electrode element 111b (which has a construction shown in FIG. 3) on each other and then rolling the laminate about the Y axis (see FIG. 2).

Although in the embodiment, the electricity generation component 111 is constructed by rolling the laminate in which the positive electrode element 111a, the separator 111c and the negative electrode element 111b are superimposed on each other, this construction is not restrictive. For example, the electricity generation component 111 can be constructed merely by superimposing the positive electrode element 111a, the separator 111c and the negative electrode element 111b.

Furthermore, although in the embodiment, the separators 111c each containing electrolytic solution is used, a solid electrolyte may be used instead of the separators 111c. Examples of the solid electrolyte that can be used include polymer solid electrolytes and inorganic solid electrolytes.

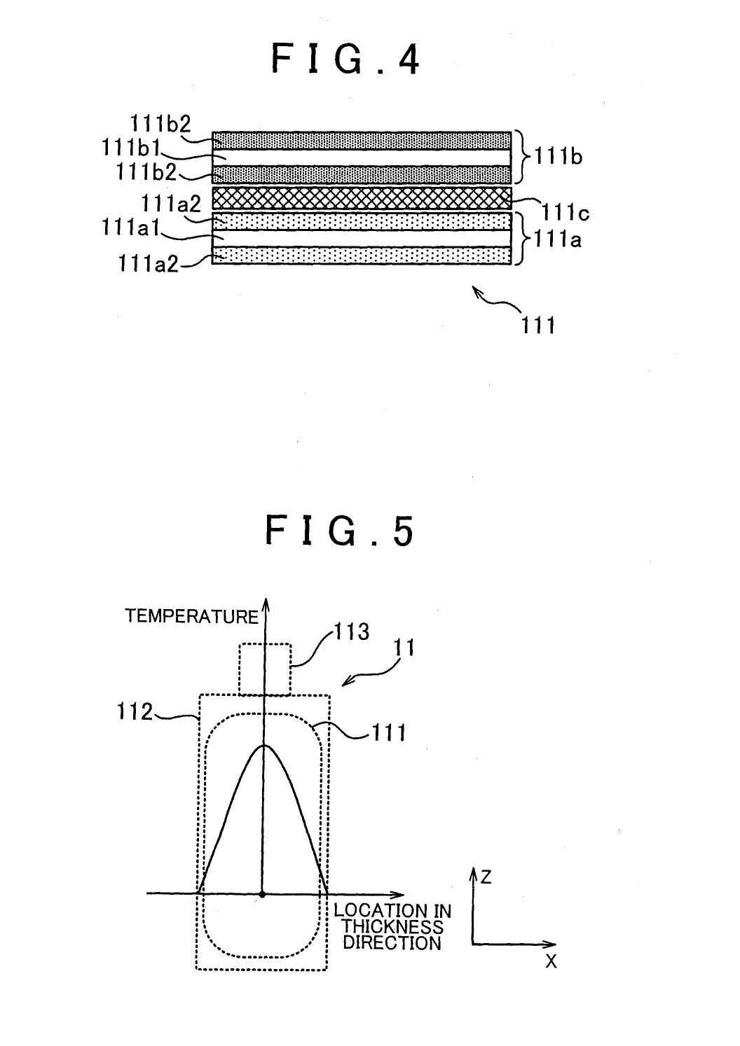

The positive electrode element 111a, as shown in FIG. 4, has a structure in which positive electrode active material layers 111a2 are formed on surfaces of a current collecting plate 111a1 . The positive electrode active material layers 111a2 contain a positive electrode active material, an electroconducting agent, etc. In the negative electrode element 111b, negative electrode active material layers 111b2 are formed on surfaces of a current collecting plate 111b1. The negative electrode active material layers 111b2 contain a negative electrode active material, an electroconducting agent, etc.

Incidentally, the constructions of the positive electrode element 111a and the negative electrode element 111b are not limited to the constructions shown in FIG. 4. For example, it is possible to use an electrode element (a bipolar electrode) in which a positive electrode active material layer is formed on a surface of a current collecting plate and a negative electrode active material layer is formed on the opposite surface of the current collecting plate.

The cell case 112 can be formed from, for example, metal. An upper surface of the cell case 112 is provided with a positive electrode terminal 113 and a negative electrode terminal 114. The positive electrode terminal 113 is electrically connected to the positive electrode element 111a of the electricity generation component 113, and the negative electrode terminal 114 is electrically connected to the negative electrode element 111b of the electricity generation component 111.

In a construction shown in FIG. 2, a temperature sensor 23 is provided on the upper surface of the cell case 112. Since the temperature sensor 23 is attached to an external surface of the electric cell 11 (cell case 112), the temperature detected by the temperature sensor 23 is a temperature on the external surface of the electric cell 11. The temperature sensor 23 used herein can be, for example, a thermocouple. Furthermore, the position at which the temperature sensor 23 is attached to the cell case 112 can be appropriately set. In a situation where a plurality of electric cells 11 are arranged in the X direction, the temperature sensor 23 can be disposed on the upper surface of the cell case 112.

Next, the temperature characteristic in an interior of the electric cell 11 will be described with reference to FIG. 5. FIG. 5 shows a coordinate system in which the vertical axis shows temperature and the horizontal axis shows the thickness of the electric cell 11, and an internal structure of the electric cell 11, in a superimposed manner. The thickness of the electric cell 11 is the length of the electric cell 11 in the X direction. A direction of the horizontal axis shown in FIG. 5 is a direction in which positive electrode elements 111a, separators 111c and negative electrode elements 111b are superimposed on each other. FIG. 5 shows a temperature distribution (an example thereof) inside the electric cell 11. A center point O shown in FIG. 5 shows the location that corresponds to the center of the electricity generation component 111 in the thickness direction of the electric cell 11.

The electric cell 11 (electricity generation component 111) produces heat due to the charging and discharging of the electric cell 11, and exhibits a temperature distribution as shown in FIG. 5, due to the heat dissipation characteristic or the like. Since the external surface of the electricity generation component 111 most readily releases heat, the temperature of the external surface is likely to be low. The external surface of the electricity generation component 111 faces the inner wall surface of the cell case 112. On the other hand, heat is less easily released and the temperature is more likely to be high with approach to the center point O.

As shown in FIG. 5, inside the electric cell 11, temperature varies depending on the location in the thickness direction of the electric cell 11. In this embodiment, temperature that corresponds to the internal resistance of the electricity generation component 111 is used as temperature of the electric cell 11 (hereinafter, referred to as “performance temperature”), and the performance temperature of the electric cell 11 is estimated as described below.

In this embodiment, in order to estimate the performance temperature of the electric cell 11, a heat conduction equation shown as the following Expression (1) is used.

$$\frac{\partial T}{\partial t} = ( \frac{λ}{ρ c} ) \frac{\partial {T}^{2}}{\partial {x}^{2}} + \frac{q}{ρ c} \qquad ( 1 )$$

In Expression (1), T represents the temperature, t represents the time, λ represents the thermal conductivity, ρ represents the density, c represents the specific heat, x represents the thermal diffusion length, and q represents the amount of heat produced per unit volume. In the right side of Expression (1), the first term is a thermal diffusion term, and the second term is a heat generation term.

Although in this embodiment, the heat conduction equation of one dimension is used, a heat conduction equation of two dimensions or three dimensions can also be used. The use of the one-dimensional heat conduction equation simplifies the computation process for estimating the performance temperature of the electric cell 11.

Expression (1) can be converted into a difference equation as in the following Expression (2).

$$\frac{{T}_{i} ( t + Δ t ) - {T}_{i} ( t )}{Δ t} = ( \frac{λ}{ρ c} ) \frac{{T}_{i + 1} ( t ) - 2 {T}_{i} ( t ) + {T}_{i - 1} ( t )}{Δ {x}^{2}} + \frac{{q}_{i} ( t )}{ρ c} \qquad ( 2 )$$

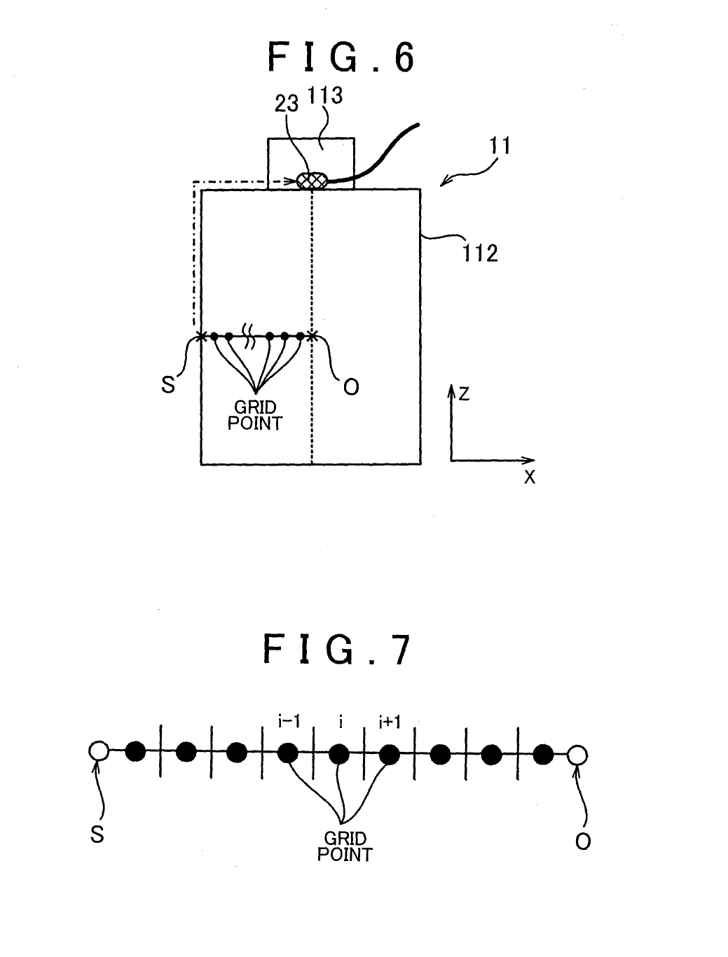

In Expression (2), i represents a grid point in the thickness direction of the electric cell 11. The grid point refer to a point within each of regions into which a region between the center point O and a point S in the thickness direction of the electric cell 11 is divided as shown in FIGS. 6 and 7. The point S is located the farthest from the center point in the thickness direction of the electric cell 11, and is located on the external surface of the cell case 112.

The number of grid points can be set as appropriate. If the number of grid points is increased, the accuracy of estimation of the temperature commensurate with the location in the thickness direction of the electric cell 11 can be improved. Furthermore, if the number of grid points is decreased, the computation process performed to estimate the temperature commensurate with the location in the thickness direction of the electric cell 11 can be simplified.

As indicated in Expression (2), the temperature of the grid point i is affected by the temperatures at the two grid points (i−1) and (i+1) adjacent to the grid point i. The temperature at the point S is considered to be the temperature that is detected by the temperature sensor 23. That is, it is considered that the temperature of the point S and the temperature of a portion where the temperature sensor 23 is attached are substantially equal to each other. If the cell case 112 is formed from a metal that is excellent in thermal conductivity, the temperature at the point S and the temperature at the site where the temperature sensor 23 is attached are substantially equal.

Although in this embodiment, the thickness direction of the electric cell 11 (X direction) is handled as a concerned direction, this is not restrictive. Since the electricity generation component 111 is a three-dimensional rectangular parallelepiped, the location in the Z direction or the Y direction can also be considered as well as the location in the X direction. It is to be noted herein that the location to be considered changes according to the heat transfer path of the electric cell 11.

Among the measurements of the electric cell 11 in the directions of the three dimensions (in the X, Y and Z directions), the measurement in the X direction is the smallest in the electric cell 11 of this embodiment. Therefore, as for the heat transfer path inside the electric cell 11, the heat transfer path along the X direction is the most dominant. Therefore, when the temperature inside the electric cell 11 is to be estimated, the temperature commensurate with the location in the thickness direction of the electric cell 11 (X direction) can be handled as a concerned temperature as in the embodiment. Incidentally, the heat transfer path is not determined only by the foregoing measurements of the electric cell 11, but can also be affected by the area of heat transfer, the material of the electric cell 11, the presence or absence of an air layer, etc. In this embodiment, as for the heat transfer path inside the electric cell 11, the heat transfer path along the X direction is set as being the most dominant, as an example.

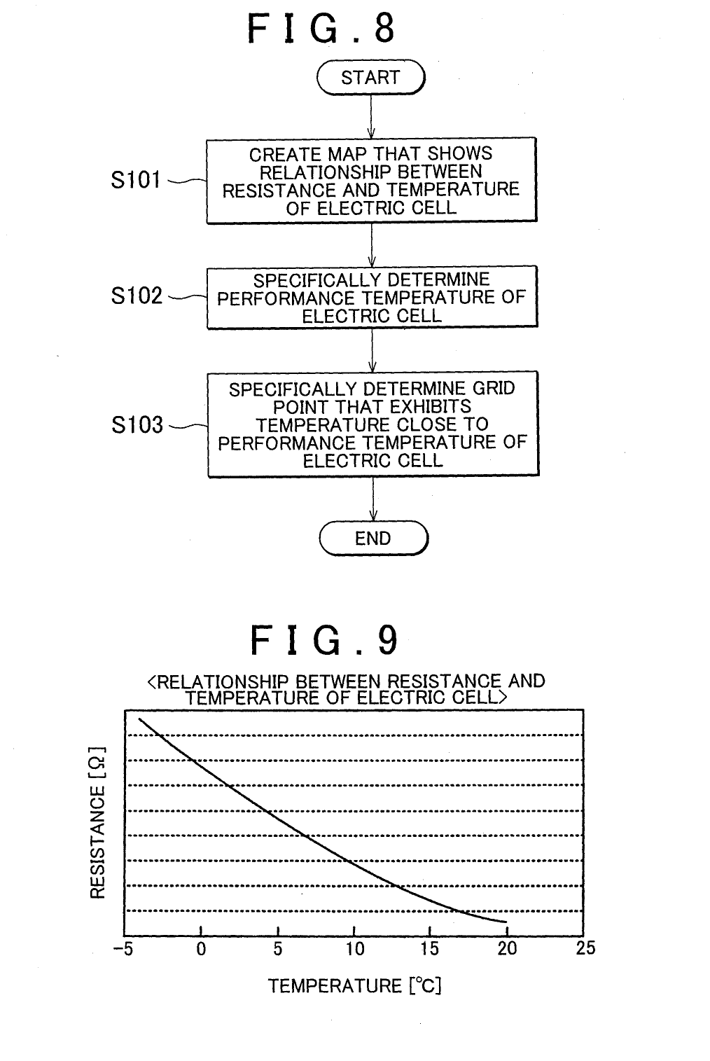

Next, a method of specifically determining a grid point i that exhibits the performance temperature of the electric cell 11 will be described. FIG. 8 is a flowchart illustrating a method of specifically determining the grid point i that exhibits the performance temperature. With reference to the flowchart shown in FIG. 8, the method of specifically determining the grid point i will be described.

In step S101, a map that shows a relationship between the resistance and the temperature of the electric cell 11 is created. Concretely, a relationship between the resistance and the temperature of the electric cell 11 is acquired. The electric cell 11 used in this example is an electric cell 11 of which the dispersion of the temperature of the interior has been reduced. That is, after the whole electric cell 11 has been caused to have a substantially uniform temperature, the resistance of the electric cell 11 is measured. In order to achieve a substantially uniform temperature in the whole electric cell 11, it suffices that, for example, the electric cell 11 is left under a condition of a specific temperature for a sufficiently long time. If the resistance of the electric cell 11 is measured while the temperature of the electric cell 11 is altered, a map, for example, one shown in FIG. 9, can be obtained.

The map shown in FIG. 9 shows that the resistance (internal resistance) and the performance temperature of the electric cell 11 have a correspondence relationship. By measuring the resistance of an electric cell 11 of which the dispersion of the temperature has been sufficiently reduced, the correspondence relationship between the internal resistance and the performance temperature of the electric cell 11 can be found. Then, using the map shown in FIG. 9, the performance temperature can be specifically determined if the resistance of the electric cell 11 is measured.

In step S102 in FIG. 8, the performance temperature of the electric cell 11 is specifically determined. This performance temperature is used to specifically determine the grid point i.

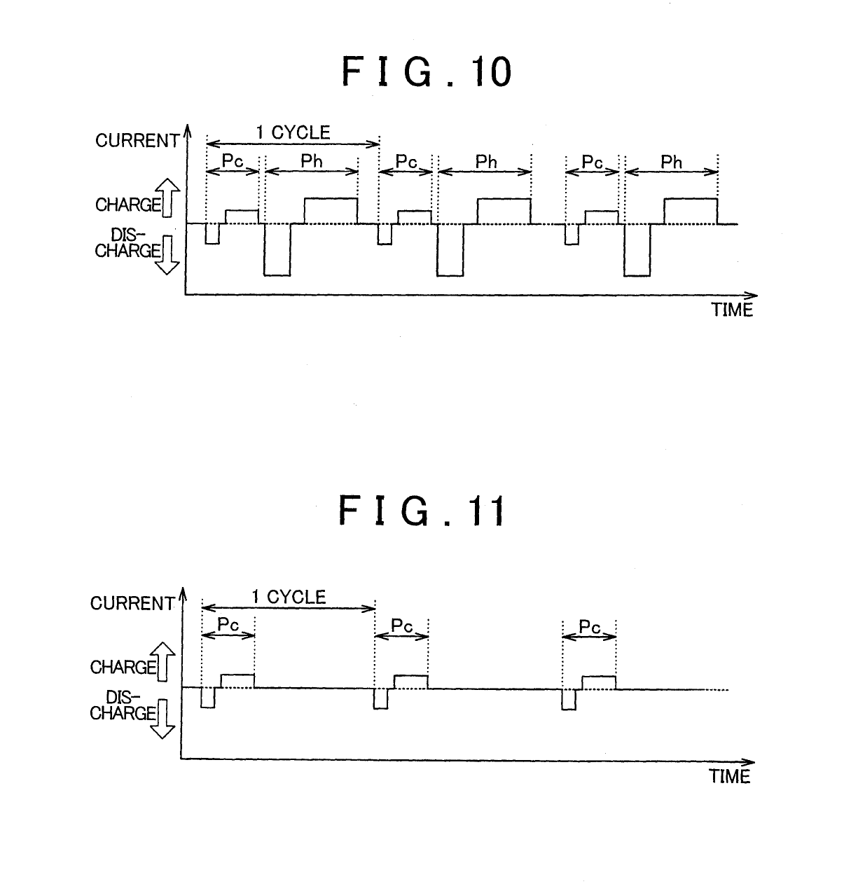

Firstly, the temperature of the electric cell 11 is detected on the basis of the output of the temperature sensor 23, by performing the charging and discharging of the electric cell 11 on the basis of patterns shown in FIGS. 10 and 11, and then a performance temperature is specifically determined by using the map shown in FIG. 9. The charging and discharging of the electric cell 11 in the pattern shown in FIG. 10 is carried out for a period during which the electric cell 11 is caused to produce heat (heat production period). The charging and discharging of the electric cell 11 in the pattern shown in FIG. 11 is carried out for a period during which the dispersion of the temperature of the electric cell 11 is decreased (temperature decrease period). After the charging and discharging in the pattern shown in FIG. 10 is performed, the charging and discharging in the pattern shown in FIG. 11 is performed.

During the heat production period, a cycle that includes the charging and discharging in a first pattern Pc and the charging and discharging in a second pattern Ph is repeatedly performed. The first pattern Pc is used to measure the resistance of the electric cell 11. The second pattern Ph is used to cause the electric cell 11 (electricity generation component 111) to produce heat. The number of charging/discharging cycles shown in FIG. 10 can be set as appropriate. Concretely, the charging/discharging cycle can be repeatedly performed until a state in which the temperature of the electric cell 11 does not easily change is achieved by causing the electric cell 11 to produce heat.

In this embodiment, the resistance of the electric cell 11 is measured at least 2 seconds after the charging and discharging of the electric cell 11 in the first pattern Pc is started. Incidentally, the time of measurement of the resistance is not limited to at least 2 seconds after the charging and discharging of the electric cell 11 in the first pattern Pc is started, but can also be set to a time other than that. It suffices that the timing at which the resistance is measured remains the same in every one of the charging/discharging cycles.

For example, the resistance of the electric cell 11 may be measured at 1 second or 10 seconds following the start of the charging and discharging in the first pattern Pc. Furthermore, the electric cell 11 may be caused to produce heat by carrying out the charging and discharging in the second pattern Ph, and the resistance occurring at at least a predetermined time may be measured. In this case, the charging and discharging in the first pattern Pc can be omitted. Furthermore, the electric cell 11 may be caused to produce heat by carrying out the charging and discharging in the first pattern

Pc.

The pattern used to measure the resistance of the electric cell 11 is not limited to the pattern shown in FIG. 10. Although in the first pattern Pc shown in FIG. 10, pulses of charging and discharging are caused to occur, it is also permissible to cause occurrence of only a pulse of charging or of discharging. Furthermore, as for the second pattern Ph shown in FIG. 10, too, it is permissible to cause occurrence of only a pulse of charging or of discharging. As for the second pattern Ph, it suffices that the electric cell 11 can be caused to produce heat.

Incidentally, if the charging and the discharging are alternately performed so that equal coulomb quantities are charged and discharged as in the first pattern Pc and the second pattern Ph shown in FIG. 10, the SOC (state of charge) of the electric cell 11 can be kept substantially constant.

After the charging/discharging cycles shown in FIG. 10 come to an end, in other words, after the heat production period ends, the charging/discharging cycle shown in FIG. 11 is repeatedly performed. In the charging and discharging shown in FIG. 11, only the charging and discharging in the first pattern Pc is performed as one cycle, and this cycle is repeatedly performed. Since in each cycle there is secured a sufficiently long rest time (a time during which the charging and discharging is not performed) from when the charging and discharging in the first pattern Pc is completed once to when the next charging and discharging starts, the temperature change of the electric cell 11 (of the electricity generation component 111) is very small.

The number of charging/discharging cycles shown in FIG. 11 can be set as appropriate. Concretely, the charging/discharging cycle shown in FIG. 11 can be repeated from when the heat production of the electric cell 11 is stopped to when a state in which the temperature of the electric cell 11 does not easily change is brought about.

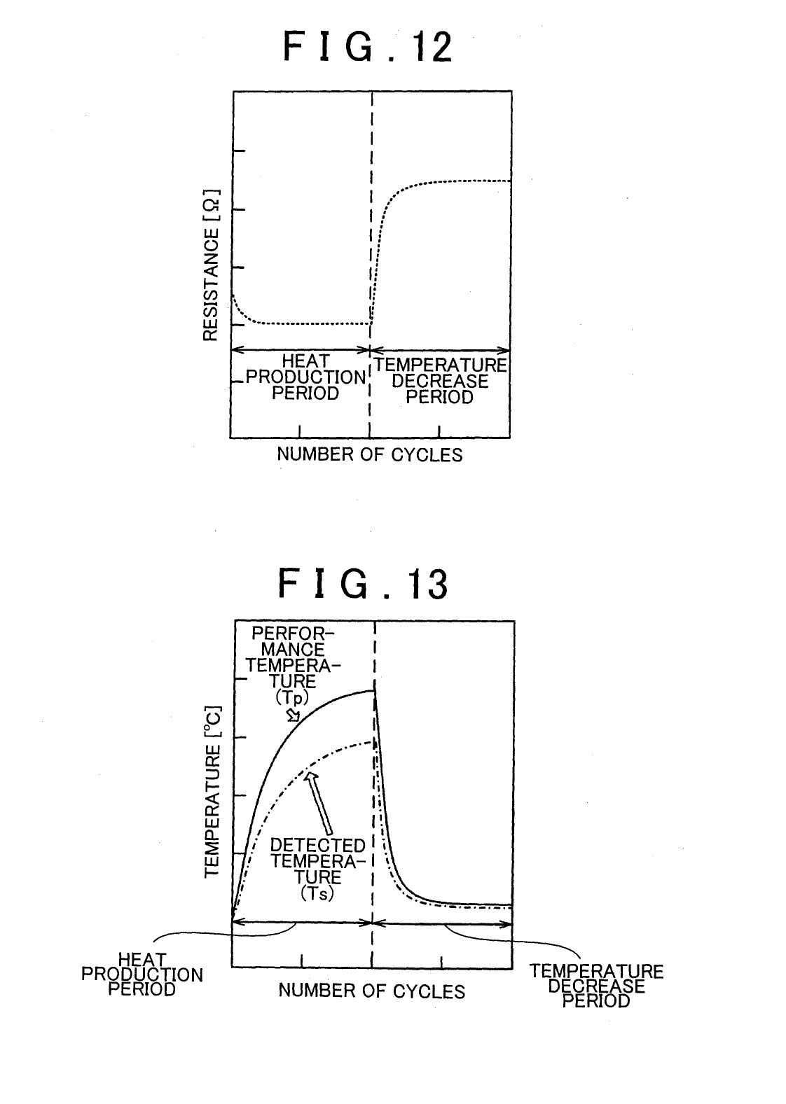

FIG. 12 shows the resistance of the electric cell 11 measured during the heat production period and the temperature decrease period. In FIG. 12, the vertical axis represents the resistance of the electric cell 11, and the horizontal axis represents the number of charging/discharging cycles (i.e., time). As shown in FIG. 12, the resistance of the electric cell 11 starts to increase at the switch from the heat production period to the temperature decrease period. The performance temperature can be specifically determined on the basis of the resistance shown in FIG. 12 and the map shown in FIG. 9.

FIG. 13 shows a relationship between the detected temperature provided by the temperature sensor 23 and the performance temperature that is specifically determined through the use of the map shown in FIG. 9. In FIG. 13, the vertical axis represents the temperature of the electric cell, and the horizontal axis represents the number of charging/discharging cycles (i.e., time). Furthermore, in FIG. 13, the distribution shown by a one-dot chain line represents the detected temperature Ts provided by the temperature sensor 23, and the distribution shown by a solid line represents the performance temperature Tp.

As shown in FIG. 13, while the detected temperature Ts and the performance temperature Tp exhibit similar behaviors, the performance temperature Tp is higher than the detected temperature Ts during the heat production period. Furthermore, the difference between the performance temperature Tp and the detected temperature Ts during the temperature decrease period is smaller than the difference between the performance temperature Tp and the detected temperature Ts during the heat production period.

In step S103 in FIG. 8, the the grid point i that exhibits a temperature change that is the closest to the temperature change in the performance temperature Tp is specifically determined. The temperature at each grid point can be calculated on the basis of the detected temperature Ts provided by the temperature sensor 23 and the heat conduction equation shown above as Expression (2). Concretely, in FIGS. 6 and 7, since the temperature at the point S is the detected temperature Ts, the use of the heat conduction equation shown above as Expression (2) allows the temperature of a grid point adjacent to the point S to be calculated.

By this calculation method, the temperatures at a plurality of grid points can be calculated. If, of the temperatures at a plurality of grid points, the temperature that is the closest to the performance temperature Tp is specifically determined, then the grid point that exhibits the performance temperature can be specifically determined. Information regarding the specifically determined grid point can be stored in the memory 30a.

If the temperature of the electric cell 11 is to be estimated, the temperature of the grid point i that corresponds to the performance temperature is calculated on the basis of the detected temperature provided by the temperature sensor 23 and the heat conduction equation shown above as Expression (2). This calculation process is carried out by the controller 30 (see FIGS. 1 and 2). Due to this, a temperature that corresponds to the internal resistance of the electric cell 11 can be estimated. The temperature of the grid point i is used as the temperature of the electric cell 11 in various controls of the electric cell 11.

Although in this embodiment, the temperature at the grid point i that corresponds to the performance temperature is calculated on the basis of the detected temperature provided by the temperature sensor 23 and the heat conduction equation, this is not restrictive. It suffices that the temperature at the grid point i that corresponds to the performance temperature can be calculated on the basis of the temperature on the external surface of the electric cell 11 and the heat conduction equation. For example, if the temperature on the external surface of the electric cell 11 can be estimated or specifically determined without using the temperature sensor 23, the temperature at the grid point i that corresponds to the performance temperature can be calculated on the basis of the estimated or specifically determined temperature and the heat conduction equation.

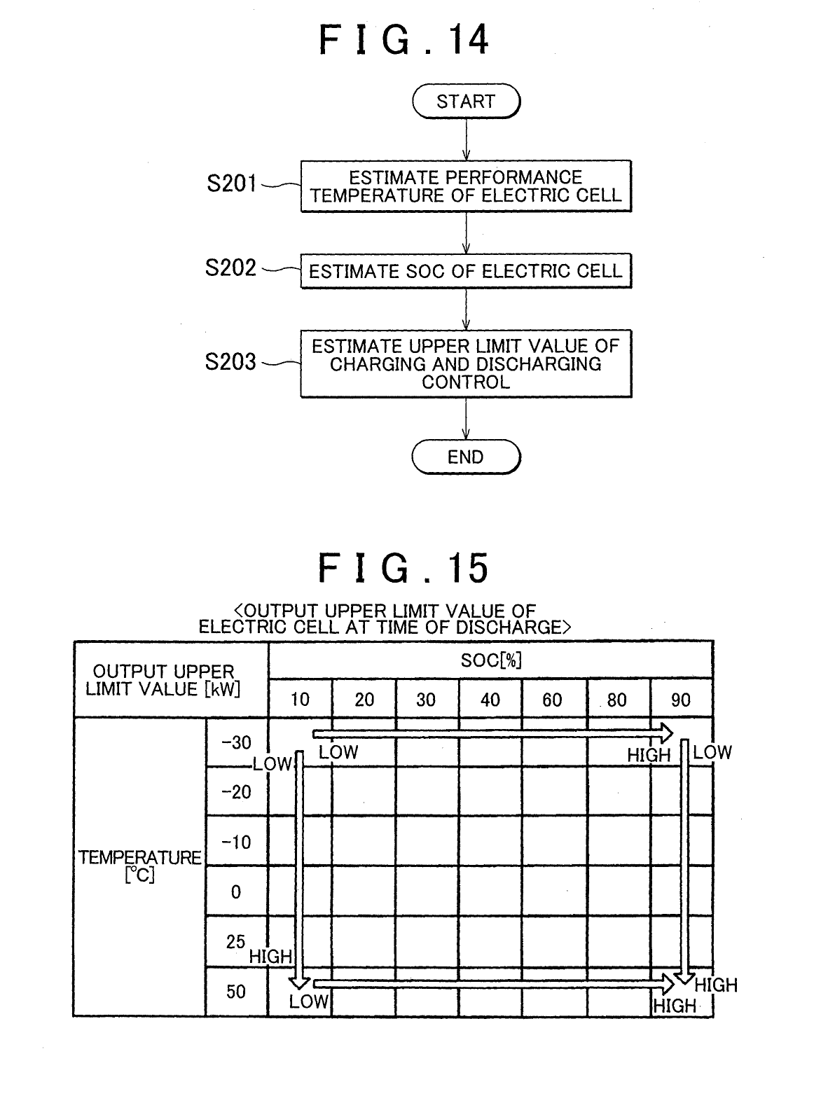

Next, a process of controlling the charging and discharging of the assembled battery 10 will be described with reference to a flowchart shown in FIG. 14. A process shown in FIG. 14 is executed by the controller 30.

When the charging and discharging of the assembled battery 10 is performed, the charging and discharging is controlled so that, for example, the input electric power and the output electric power of the assembled battery 10 do not exceed upper limit values. The upper limit values are values determined beforehand in order to protect the assembled battery 10 (the electric cell 11), and are appropriately set. That is, the charging and discharging of the assembled battery 10 is permitted until the input electric power or the output electric power of the assembled battery 10 reaches a corresponding one of the upper limit values.

For example, when the assembled battery 10 is discharged, the discharging of the assembled battery 10 is restricted when the output electric power of the assembled battery 10 reaches the upper limit value (the upper limit value that corresponds to the output of the assembled battery 10). Examples of the case where the discharging of the assembled battery 10 is restricted include the case where the discharging is prohibited and the case where the upper limit value corresponding to the output is changed in the lowering direction. If the upper limit value is lowered, the electric power that is permitted as output of the assembled battery 10 is reduced or restrained.

Furthermore, when the assembled battery 10 is charged, the charging of the assembled battery 10 is restricted if the input electric power of the assembled battery 10 reaches the upper limit value (the upper limit value that corresponds to the input to the assembled battery 10). Examples of the case where the charging of the assembled battery 10 is restricted include the case where the charging is prohibited and the case where the upper limit value corresponding to the input is changed in the lowering direction. If the upper limit value is changed in the lowering direction, the electric power that is permitted as the input to the assembled battery 10 is reduced or restrained.

In the charging-discharging control of the assembled battery 10, there are a case where the state of the assembled battery 10 is monitored and the charging and discharging thereof is controlled, and a case where the state of the electric cell 11 is monitored and the charging and discharging thereof is controlled. Examples of the state of the assembled battery 10 or the electric cell 11 include the voltage, the current and the temperature thereof.

The process shown in FIG. 14 is a process of setting the upper limit values that are used in the charging-discharging control of the assembled battery 10. In step S201, the controller 30 calculates the temperature at the grid point i that corresponds to the performance temperature as described above. In step S202, the controller 30 estimates the SOC (state of charge) of the electric cell 11. The SOC of the electric cell 11 can be estimated by various methods.

For example, the controller 30 acquires the value of current occurring at the time of the charging or discharging of the electric cell 11, from the output of the electric current sensor 22. The controller 30 is able to estimate the SOC of the electric cell 11 by accumulating the acquired values of current. It is to be noted herein that, for example, with regard to the value detected by the electric current sensor 22, the discharge current may be defined as positive value, and the charge current may be defined as negative value.

The SOC can be estimated from a measured OCV (open circuit voltage) of the electric cell 11. Since the OCV and the SOC are in a correspondence relationship, the SOC can be specifically determined by measuring the OCV if a map that shows the correspondence relationship is prepared beforehand.

In step S203, the controller 30 sets upper limit values for use in conjunction with the discharge (output) and the charge (input) of the electric cell 11, on the basis of the temperature calculated in step S201 and the SOC estimated in step S202.

FIG. 15 shows a map that shows a relationship of the upper limit value for use at the time of discharging the electric cell 11 (referred to as the output upper limit value) with the temperature and the SOC of the electric cell 11. The map shown in FIG. 15 can be prepared and stored in the memory 30a beforehand.

FIG. 15 shows changes in the output upper limit value with changes in the SOC and the temperature. Concretely, when the SOC is a fixed value, the output upper limit value decreases with decreases in the temperature of the electric cell 11. As the temperature decreases, the chemical reaction occurring at the time of discharge is restrained more, so that it is preferred that the output of the electric cell 11 is restrained more. Therefore, the output upper limit value is decreased with decreases in the temperature. The map as shown in FIG. 15 may include a case where the output upper limit value does not change despite a change in the temperature.

On the other hand, when the temperature of the electric cell 11 is a fixed value, the output upper limit value decreases with decreases in the SOC. As the SOC of the electric cell 11 decreases, it becomes more difficult to discharge the electric cell 11. Therefore, with decreases in the SOC, the output upper limit value is decreased. The map as shown in FIG. 15 may include a case where the output upper limit value does not change despite a change in the SOC.

The temperature in the map shown in FIG. 15 is the temperature calculated in step S201. The SOC in the map shown FIG. 15 is the SOC estimated in step S202. If the temperature and the SOC of the electric cell 11 are specifically determined, the output upper limit value can be specifically determined form the map shown in FIG. 15. Then, with reference to the set output upper limit value, the discharging control of the electric cell 11 (the assembled battery 10) is performed.

While FIG. 15 shows the upper limit value that is used when the electric cell 11 is discharged, it is also appropriate that a map that corresponds to the map shown in FIG. 15 be also prepared for the upper limit value that is used when the electric cell 11 is charged. Then, by using a method substantially the same as the method for specifically determining the output upper limit value, the upper limit value that is used when the electric cell 11 is charged (referred to as “input upper limit value”) can be specifically determined.

When the SOC of the electric cell 11 is a fixed value, the input upper limit value can be decreased with decreases in the temperature of the electric cell 11. It is to be noted herein that the input upper limit value may be kept unchanged despite a change in the temperature. Furthermore, when the temperature of the electric cell 11 is a fixed value, the input upper limit value can be decreased with increases in the SOC. Since it becomes more difficult to change the electric cell 11 as the SOC of the electric cell 11 increases, the input upper limit value is decreased with increases in the SOC. With reference to the set input upper limit value, the charging control of the electric cell 11 (the assembled battery 10) is performed.

Although in the embodiment, the output upper limit value is specifically determined by using the map shown in FIG. 15, this is not restrictive. Concretely, when the output upper limit value is expressed by a function whose variables are the temperature and the SOC of the electric cell 11, the output upper limit value can be calculated by using this function. In this case, it suffices that information regarding the function whose variables are the temperature and the SOC of the electric cell 11 is stored in the memory 30a beforehand.

Furthermore, although in this embodiment, the upper limit values that are used in the charging-discharging control are set on the basis of the temperature and the SOC of the electric cell 11, this is not restrictive. Concretely, the upper limit values that are used in the charging-discharging control can also be set on the basis of only the temperature of the electric cell 11.

According to the embodiment, since the upper limit values (the output upper limit value and the input upper limit value) that correspond to the performance temperature of the electric cell 11 are set, it is possible to perform the charging and discharging of the electric cell 11 commensurate with the input/output characteristic of the electric cell 11. The performance temperature of the electric cell 11 is the temperature that corresponds to the internal resistance of the electric cell 11, and the input/output characteristic of the electric cell 11 depends on the internal resistance of the electric cell 11. Therefore, if upper limit values that correspond to the performance temperature of the electric cell 11 is set, the charging and discharging of the electric cell 11 commensurate with the performance of the electric cell 11 can be performed.

As described above with reference to FIG. 5, the surface temperature of the electric cell 11 (the temperature at the point S) tends to be lower than the the performance temperature of the electric cell 11. Therefore, if the output upper limit value or the input upper limit value is set on the basis of the surface temperature of the electric cell 11, the charging and discharging of the electric cell 11 can sometimes be excessively restricted. On the other hand, the temperature at the center of the electric cell 11 (the electricity generation component 111) tends to be higher than the performance temperature. Therefore, if the output upper limit value and the input upper limit value are set on the basis of the temperature at the center of the electric cell 11 (the highest temperature thereof), the charging and discharging of the electric cell 11 can sometimes be excessively performed.

A second embodiment of the invention will be described. In the first embodiment, of the plurality of grid points provided in the thickness direction of the electric cell 11, a grid point that corresponds to the performance temperature is specifically determined, and then the temperature at the specifically determined grid point is estimated as the temperature of the electric cell 11. In the second embodiment, only three grid points are used to calculate the performance temperature of the electric cell 11. Hereinafter, features of this embodiment will be concretely described. Incidentally, the members that have the same functions as those described above in conjunction with the first embodiment will be denoted by the same reference characters, and detailed descriptions thereof will be omitted.

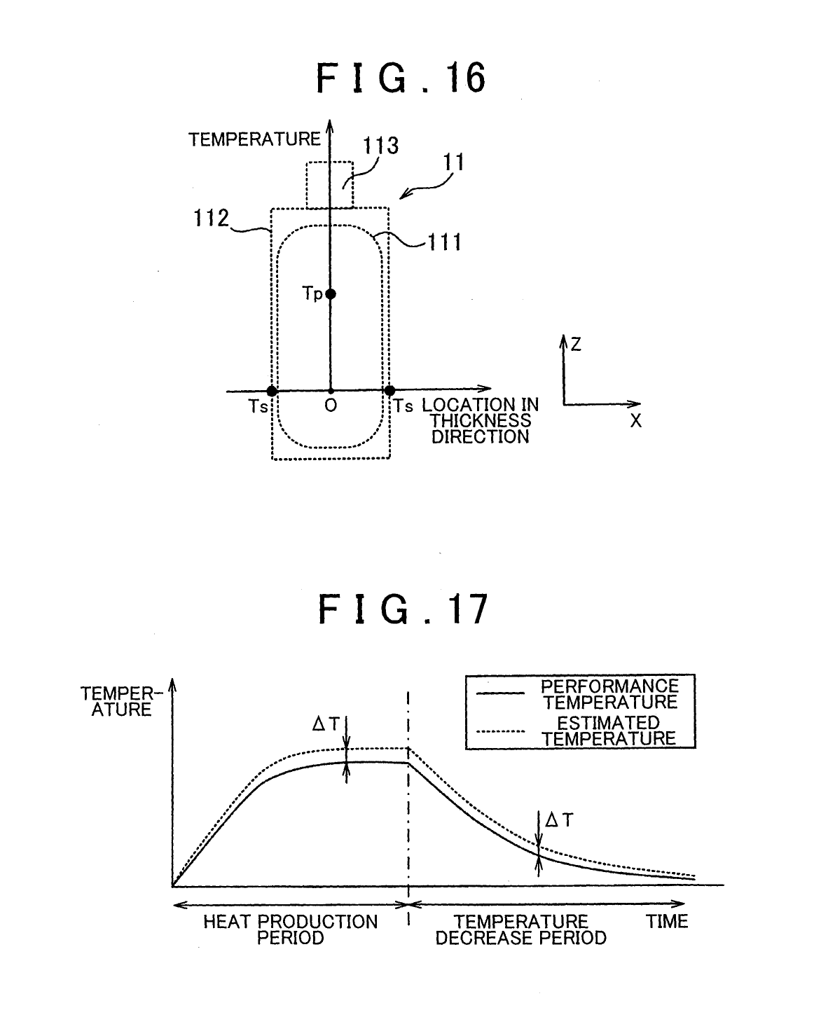

FIG. 16 shows a relationship between the temperature and the location in the thickness direction of the electric cell 11 where three grid points are set. In the example shown in FIG. 16, of the three grid points, a grid point inside the electric cell 11 is assumed to have a performance temperature Tp, and the two grid points on the surface of the electric cell 1 are assumed to have a temperature that is equal to the detected temperature Ts detected by the temperature sensor 23. It is to be noted herein that instead of the detected temperature Ts, the temperatures at other grid points may be used.

The heat conduction equation in the case where the number of grid points set is three can be simplified as in the following Expression (3).

$$\frac{{T}_{p} ( t + Δ t ) - {T}_{p} ( t )}{Δ t} = {k}_{1} ( \frac{λ}{ρ c} ) \frac{{T}_{s} ( t ) - 2 {T}_{p} ( t ) + {T}_{s} ( t )}{Δ {x}^{2}} + {k}_{2} \frac{{q}_{p} ( t )}{ρ c} \qquad ( 3 )$$

Furthermore, Expression (3) can be expressed by the following Expression (4).

Tₛ(t+Δt)=Tₚ(t)+α(Tₛ(t)−Tₚ(t))+βqₚ(t) (4)

As for Expression (4), α and β are expressed by the following Expressions (5) and (6).

$$\begin{matrix}α = \frac{2 {k}_{1} λ Δ t}{ρ c Δ {x}^{2}} & ( 5 ) \\ β = \frac{{k}_{2} Δ t}{ρ c} & ( 6 )\end{matrix}$$

In Expression (3) and Expressions (5) and (6), k₁ and k₂ are correction coefficients, and can be determined, for example, by methods described below.

As described above with reference to FIG. 13, the performance temperature of the electric cell 11 is calculated beforehand. Then, temperatures estimated as the performance temperature (which will be referred to as estimated temperatures) are calculated through the use of Expressions (3) and (4) while the correction coefficients k₁ and k₂ are respectively altered. Then, the correction coefficients k₁ and k₂ that provide an estimated temperature whose difference from the performance temperature is the smallest are specifically determined.

FIG. 17 shows a relationship (an example thereof) between the performance temperature and the estimated temperature. During the heat production period, the electric cell 11 is caused to produce heat by performing the charging and discharging in the first pattern Pc and the second pattern Ph alternately, as in the first embodiment. During the temperature decrease period, the charging and discharging only in the first pattern Pc is performed as in the first embodiment, so that the temperature of the electric cell 11 is brought to a temperature commensurate with the environment without causing the electric cell 11 to produce heat.

Incidentally, by performing the charging and discharging in the second pattern Ph, it is possible to measure the resistance of the electric cell 11 occurring after a predetermined time while causing the electric cell 11 to produce heat. In this case, the charging and discharging in the first pattern Pc can be omitted. Furthermore, the electric cell 11 can also be caused to produce heat by performing the charging and discharging in the first pattern Pc.

As described above in conjunction with the first embodiment, it is possible to measure the resistance of the electric cell 11 during the heat production period and during the temperature decrease period and specifically determine the performance temperature by using the measured resistances and the map shown in FIG. 9. The distribution of the performance temperature is shown by a solid line in FIG. 17. On another hand, the detected temperatures acquired from the temperature sensor 23 during the heat production period and during the temperature decrease period are substituted in the heat conduction equation shown above as in Expression (3) and the correction coefficients k₁ and k₂ are appropriately set, so as to specifically determine the estimated temperature. The distribution of the estimated temperature (an example thereof) is shown by a dotted line in FIG. 17.

If the estimated temperature is higher than the performance temperature as shown in FIG. 17, the correction coefficients k₁ and k₂ are altered so that the estimated temperature decreases to approach the performance temperature. If the estimated temperature is lower than the performance temperature, the correction coefficients k₁ and k₂ are altered so that the estimated temperature increases to approach the performance temperature. That is, the correction coefficients k₁ and k₂ are determined so that the difference ΔT between the estimated temperature and the performance temperature approaches zero.

It is to be noted herein that a process of determining the correction coefficients k₁ and k₂ can be carried out on the basis of the difference ΔT between the performance temperature and the estimated temperature occurring during the heat production period or on the basis of the difference ΔT between the performance temperature and the estimated temperature occurring during the temperature decrease period. The thus-obtained correction coefficients k₁ and k₂ (or α and β) can be stored in the memory 30a. Thus, the performance temperature Tp can be calculated on the basis of Expression (3) if the detected temperature Ts provided by the temperature sensor 23 is acquired.

In this embodiment, too, the performance temperature Tp that corresponds to the internal resistance can be calculated. If the performance temperature is used as the temperature of the electric cell 11, the upper limit values (the output upper limit value and the input upper limit value) that are used in the charging-discharging control of the electric cell 11 can be set on the basis of the performance temperature as in the first embodiment. Furthermore, in the second embodiment, the performance temperature Tp is calculated by employing the least possible number of grid points, the computation load in calculating the performance temperature Tp can be reduced.

Although in the second embodiment, the temperature at a grid point i that corresponds to the performance temperature is calculated on the basis of the temperature on the external surface of the electric cell 11 and the heat conduction equation, this is not restrictive. Concretely, the temperature at a grid point i that corresponds to the performance temperature can also be calculated by acquiring the temperature occurring outside the electric cell 11 beforehand and using an expression that expresses movement of heat.

The temperature occurring outside the electric cell 11 includes not only the temperature occurring on the external surface of the electric cell 11 but also the temperature occurring at a location apart from the external surface of the electric cell 11. The temperature occurring apart from the external surface of the electric cell 11 can be detected by using the temperature sensor 23. The location apart from the external surface of the electric cell 11 may be, for example, a location where a heat exchange medium is supplied to the electric cell 11 (e.g., a supply opening for the heat exchange medium) if such a heat exchange medium (a gas or a liquid) is supplied to the electric cell 11 so as to adjust the temperature of the electric cell 11.

The expression that expresses movement of heat is an expression that expresses movement of heat from outside the electric cell 11 to the grid point i that corresponds to the performance temperature. Examples of the expression that expresses movement of heat include not only the heat conduction equation described above in conjunction with the embodiments but also an expression that expresses heat transfer and an expression based on a model of a thermal equivalent circuit.

When the temperature occurring at a location apart from the external surface of the electric cell 11 is to be acquired, the temperature at the grid point i that corresponds to the performance temperature can be calculated by factoring in the heat transfer from the location apart from the external surface of the electric cell 11 to the external surface of the electric cell 11 and the heat conduction inside the electric cell 11. It is to be noted herein that the temperature at the grid point i can be calculated by evaluating the heat transfer and the heat conduction separately or the temperature at the grid point i can also be calculated by collectively evaluating the heat transfer and the heat conduction.

If an expression that expresses the heat transfer is used, the expression that expresses the heat transfer can be determined as appropriate by taking into account the movement of heat from the location apart from the external surface of the electric cell 11 to the external surface of the electric cell 11. When the heat conduction inside the electric cell 11 or the heat transfer from the location apart from the external surface of the electric cell 11 to the external surface of the electric cell 11 is to be evaluated, it is possible to use a model of a thermal equivalent circuit as well as the heat conduction equations described above in conjunction with the embodiments. In a thermal equivalent circuit model, the heat transfer or the heat conduction can be expressed by using the heat capacity C and the thermal resistance R while taking into account how heat propagates inside the electric cell 11. Then, on the basis of the thermal equivalent circuit model, an expression that expresses the heat conduction inside the electric cell 11 can be determined as appropriate.

1. A control method that controls charging and discharging of an electricity storage device, comprising:
calculating temperature of a reference point inside the electricity storage device by using temperature occurring outside the electricity storage device and an expression that expresses movement of heat, the reference point being a grid point that exhibits temperature that corresponds to internal resistance of the electricity storage device, of a plurality of grid points provided inside the electricity storage device; and
setting an upper-limit electric power that is used in a charging control of the electricity storage device or a discharging control of the electricity storage device to an electric power that corresponds to the calculated temperature of the reference point.

2. The control method according to claim 1, further comprising
setting the upper-limit electric power to an electric power that corresponds to the calculated temperature of the reference point and to state of charge of the electricity storage device.

3. The control method according to claim 1, further comprising
calculating the temperature of the reference point by using temperature on an external surface of the electricity storage device and a heat conduction equation.

4. The control method according to claim 3, wherein
the heat conduction equation is expressed as in the following Expression (I)
$$\frac{{T}_{i} ( t + Δ t ) - {T}_{i} ( t )}{Δ t} = ( \frac{λ}{ρ c} ) \frac{{T}_{i + 1} ( t ) - 2 {T}_{i} ( t ) + {T}_{i - 1} ( t )}{Δ {x}^{2}} + \frac{{q}_{i} ( t )}{ρ c} \qquad ( I )$$
where T is temperature, t is time, λ is thermal conductivity, ρ is density, c is specific heat, x is thermal diffusion length, q is amount of heat production per unit volume, and a subscript i indicates a value occurring at the reference point.

5. The control method according to claim 3, wherein
the heat conduction equation is expressed as in the following Expression (II)
$$\frac{{T}_{p} ( t + Δ t ) - {T}_{p} ( t )}{Δ t} = {k}_{1} ( \frac{λ}{ρ c} ) \frac{{T}_{s} ( t ) - 2 {T}_{p} ( t ) + {T}_{s} ( t )}{Δ {x}^{2}} + {k}_{2} \frac{{q}_{p} ( t )}{ρ c} \qquad ( II )$$
where Tₚ is the temperature at the reference point, Tₛ is the temperature on the external surface of the electricity storage device, t is time, λ is thermal conductivity, ρ is density, c is specific heat, x is thermal diffusion length, qₚ is amount of heat production per unit volume at the reference point, and k₁ and k₂ are correction coefficients.

6. The control method according to any one of claims 1, further comprising:
measuring the internal resistance of the electricity storage device;
creating a map that shows a relationship between the temperature of the electricity storage device and the internal resistance of the electricity storage device by using the electricity storage device whose temperature distribution has been uniformed;
specifically determining the temperature that corresponds to the measured internal resistance by using the map; and
calculating the temperatures occurring at the plurality of grid points by using the temperature occurring outside the electricity storage device and the expression that expresses movement of heat, the reference point being a grid point, of the plurality of grid points, that exhibits a temperature that is closest to the temperature that corresponds to the internal resistance.

7. The control method according to claim 1, wherein:
the electricity storage device has an electricity generation component and a case that houses the electricity generation component;
the electricity generation component is configured by superimposing a positive electrode element, a separator and a negative electrode element on each other; and
the plurality of grid points are different from each other in location in a superimposition direction of the electricity generation component.

8. A control apparatus that controls charging and discharging of an electricity storage device, comprising:
a controller that calculates temperature of a reference point inside the electricity storage device by using temperature occurring outside the electricity storage device and an expression that expresses movement of heat, and that sets an electric power that corresponds to the calculated temperature of the reference point as an upper-limit electric power that is used in a charging control of the electricity storage device or a discharging control of the electricity storage device, the reference point being a grid point that exhibits temperature that corresponds to internal resistance of the electricity storage device, of a plurality of grid points provided inside the electricity storage device.

9. The control apparatus according to claim 8, further comprising:
a temperature sensor that detects the temperature occurring outside the electricity storage device.

10. The control apparatus according to claim 8, further comprising
a memory that stores data that indicates a correspondence relationship between the upper-limit electric power and the temperature, wherein
the controller sets the upper-limit electric power by using the data stored in the memory.

11. The control apparatus according to claim 8, wherein
the controller sets an electric power that corresponds to the calculated temperature of the reference point and to state of charge of the electricity storage device as the upper-limit electric power.

12. The control apparatus according to claim 8, wherein
the controller calculates the temperature of the reference point by using temperature on an external surface of the electricity storage device and a heat conduction equation.

13. The control apparatus according to claim 12, wherein
the heat conduction equation is expressed as in the following Expression (III)
$$\frac{{T}_{i} ( t + Δ t ) - {T}_{i} ( t )}{Δ t} = ( \frac{λ}{ρ c} ) \frac{{T}_{i + 1} ( t ) - 2 {T}_{i} ( t ) + {T}_{i - 1} ( t )}{Δ {x}^{2}} + \frac{{q}_{i} ( t )}{ρ c} \qquad ( III )$$
where T is temperature, t is time, λ is thermal conductivity, ρ is density, c is specific heat, x is a thermal diffusion length, q is amount of heat production per unit volume, and a subscript i indicates a value occurring at the reference point.

14. The control apparatus according to claim 12, wherein
the heat conduction equation is expressed as in the following Expression (IV)
$$\frac{{T}_{p} ( t + Δ t ) - {T}_{p} ( t )}{Δ t} = {k}_{1} ( \frac{λ}{ρ c} ) \frac{{T}_{s} ( t ) - 2 {T}_{p} ( t ) + {T}_{s} ( t )}{Δ {x}^{2}} + {k}_{2} \frac{{q}_{p} ( t )}{ρ c} \qquad ( IV )$$
where Tₚ is the temperature at the reference point, Tₛ is the temperature on the external surface of the electricity storage device, t is time, λ is thermal conductivity, ρ is density, c is specific heat, x is thermal diffusion length, qₚ is amount of heat production per unit volume at the reference point, and k₁ and k₂ are correction coefficients.

15. The control apparatus according to claim 8, wherein
the controller measures the internal resistance of the electricity storage device and, using a map that is created by using the electricity storage device whose temperature distribution has been uniformed and that shows a relationship between the temperature of the electricity storage device and the internal resistance of the electricity storage device, specifically determines the temperature that corresponds to the measured internal resistance, and calculates the temperatures occurring at the plurality of grid points by using the temperature occurring outside the electricity storage device and the expression that expresses movement of heat, the reference point being a grid point, of the plurality of grid points, that exhibits a temperature that is closest to the temperature that corresponds to the internal resistance.

16. The control apparatus according to claim 8, wherein
the electricity storage device has an electricity generation component and a case that houses the electricity generation component;
the electricity generation component is configured by superimposing a positive electrode element, a separator and a negative electrode element on each other; and
the plurality of grid points are different from each other in location in a superimposition direction of the electricity generation component.
